(19) United States
(12) Patent Application Publication
(10) Pub. No.: US 2026/0339396 A1
(43) Pub. Date: Oct. 29, 2026

(54) CUSTOMIZABLE HEAD MOUNTED DISPLAY SYSTEM

(71) Applicant: Charles Giangreco, Orlando, FL (US)

(72) Inventor: Charles Giangreco, Orlando, FL (US)

(21) Appl. No.: 19/646,957

(22) Filed: Apr. 14, 2026

Related U.S. Application Data
(60) Provisional application No. 63/796,906, filed on Apr. 29, 2025.

(51) Int. Cl. G06F 1/16; G06F 3/14; G06F 3/16

(52) U.S. Cl. CPC G06F 1/1654; G06F 1/166; G06F 3/1454; G06F 3/16

(57) ABSTRACT

A customizable display system includes a head engagement device having an elongated headband that is shaped and sized for engaging the head of a user. The headband includes at least one mount and at least one display assembly that are positioned along the exterior surface. Each display assembly includes a fanciful-shaped housing and a forward-facing display screen. Embodiments of the system also include a speaker and a rear facing display screen. A controller having a processor and a wireless communication unit is connected to the display screens and speaker. A mobile application is provided for communicating with the wireless communication unit of the controller. The mobile application functioning to supply operating instructions and content to the controller for playback on the display screens and speaker.

### CROSS-REFERENCE TO RELATED APPLICATIONS

This application claims the benefit of U.S. application Ser. No. 63/796,906 filed on Apr. 29, 2025, the contents of which are incorporated herein by reference.

### TECHNICAL FIELD

The present invention relates generally to electronic displays, and more particularly to a display system that is worn on or about the head of a user for displaying content to others.

### BACKGROUND

The statements in this section merely provide background information related to the present disclosure and may not constitute prior art.

When people attend events such as concerts, sporting contests, theme parks, and other such activities, they want to feel like they are part of the action, and not just a passive spectator. Because these environments are typically high-energy events, many users like to feel like they're part of the show. For example, at a concert fans often dress like their favorite artist or wear clothing that references a specific song or era. At a sporting event, fans will often wear sporting jerseys and hold signs displaying loyalty, humor, or rivalry. At theme parks, visitors will often wear outfits and/or props to reflect their favorite characters or stories.

There's also a strong desire to be seen and recognized. Signs, especially, are often made with the hope of catching attention from a camera crew, a performer, or other fans. Even without that recognition, people enjoy the reactions they get from those around them, and the more unique they are, the better the experience.

The present invention, directed to a head mounted display system differs from the conventional art in a number of aspects. The manner by which will become more apparent in the description which follows, particularly when read in conjunction with the accompanying drawings.

### SUMMARY OF THE INVENTION

The present invention is directed to a customizable wearable display system. One embodiment of the present invention can include a head engagement device having an elongated headband that is shaped and sized for engaging the head of a user. The headband can include one or more mounts along the exterior surface for engaging one or more display assemblies.

In one embodiment, each of the display assemblies can include a housing and a forward-facing display screen. The forward-facing display screen can function to play visual content, and each of the housing and forward-facing display screen can include fanciful shapes.

In one embodiment, the system can also include a speaker, and the display assemblies can include a rear facing display screen.

In one embodiment, the system can include a controller that can communicate wirelessly with a smartphone via a mobile application. The mobile application can allow a user to send content from the smartphone to the controller, and to control an operation of each of the display screens and speaker of the system.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a customizable head mounted display system that is useful for understanding the inventive concepts disclosed herein.

FIG. 2 is a front view of the head engagement device of the system, in accordance with one embodiment of the invention.

FIG. 3A is a front view of the head engagement device and display assemblies of the system, in accordance with one embodiment of the invention.

FIG. 3B is a back view of the system, in accordance with one embodiment of the invention.

FIG. 4 is a simplified block diagram of the system controller, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Any element in a claim that does not explicitly state “means” for performing a specified function or “step” for performing a specified function should not be interpreted as a “means” or “step” clause as specified in 35 U.S.C. 112.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances, or the like.

As described herein, a “fanciful shape” refers to the deliberate shaping of an object to characterize an imaginative, whimsical, or capricious design rather than functional or realistic representations.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors”.

Several nonlimiting examples of connectors include, but are not limited to, flexible straps with a series of serrations along their lengths and pawls or ratchets along one of the ends (i.e., zip ties), thread-to-connect, twist-to-connect, and push-to-connect type devices, opposing strips of hook and loop material (e.g., Velcro®), attractively-oriented magnetic elements or magnetic and metallic elements, buckles, clamps, sockets, clips, carabiners, and compression fittings, for example.

Each illustrated connector can be permanently secured to the illustrated portion of the device via a permanent sealer such as glue, adhesive tape, or stitching, for example.

Moreover, the term “permanently secured” shall be used to describe a situation wherein two or more objects are joined together in a manner so as to prevent the same objects from being separated. Several nonlimiting examples of permanent connectors include various adhesives such as glue or resin, hardware such as nuts and bolts, and welds, for example.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “resilient” is defined as the ability of a component to maintain a particular shape and to attempt to return to the particular shape after being bent, folded, twisted or otherwise manipulated.

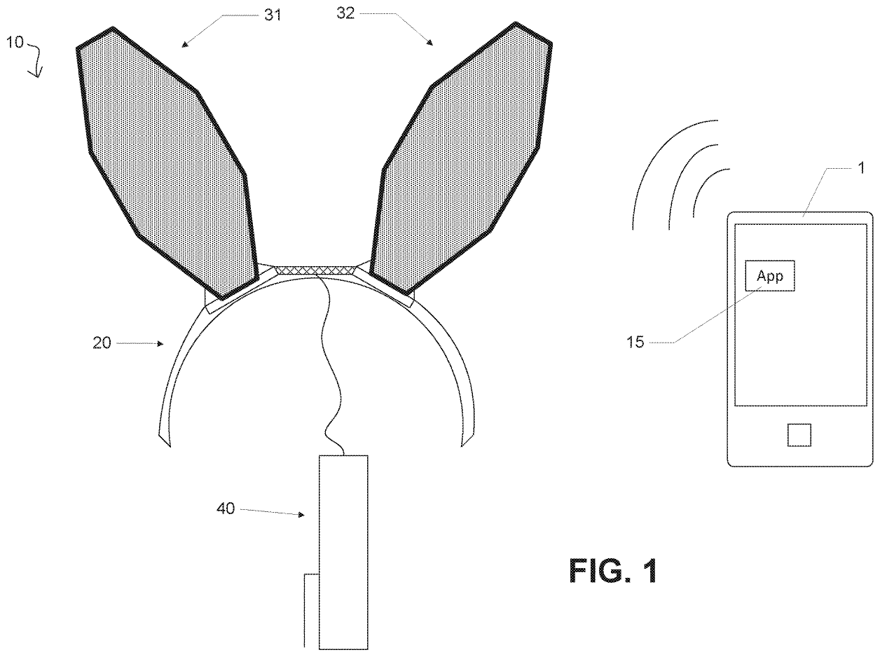

FIGS. 1-4 illustrate one embodiment of a customizable head mounted display system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of the system 10. As shown, the system can include a head engagement device 20, one or more display assemblies 31 and 32, and a control unit 40 that can communicate with an external device 1 running a mobile application 15.

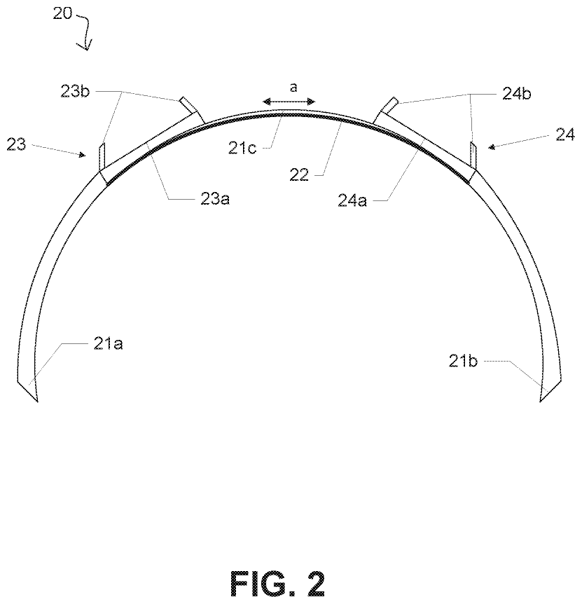

As shown best at FIG. 2, the head engagement device 20 can include any number of different shapes, sizes and components suitable for engaging a human head in a secure manner, and for positioning each of the display screens above the top of the user's head so as to be viewable by others. The positioning of the display screens is an important feature as 1) in some embodiments the display screens can be shaped to resemble fanciful ears or other body parts, 2) the elevated location of the displays maximizes viewing (both from the front and back sides) by others without the users body blocking the display(s), and 3) the elevated positioning results in the user not being able to see the displays, and thus ensures the user is not distracted or disoriented by the display when participating in an event.

In one embodiment, the head engagement device 20 can take the form of a headband that includes a semicircular-shaped body having a first end 21a, a second end 21b, and a middle section 21c. The body is designed to follow the contour of a user's head such that each end 21a/21b is positionable behind the ears of a user with the middle section 21 c located along the top of the user's head.

The body can be constructed from any number of resilient semi-rigid materials such as plastic or metal, for example, that provide both strength and a small amount of elasticity. In one embodiment, the inside facing surface of the headband can include padding 22 for added comfort. The resilient nature of the headband functions to allow a user to flex the body outward when securing the device onto their head, at which time the body will apply gentle inward pressure to maintain the band securely in place.

Although described above with regard to a headband-style component, this is for illustrative purposes only. To this end, other embodiments are contemplated wherein the head mount includes or comprises an adjustable head strap that is positioned securely around the circumference of the head, and includes one or more top straps that pass over the top of the users head to engage the displays and help distribute the weight of the displays downward without slipping. Likewise, other embodiments are contemplated wherein the engagement device includes components optimized for engaging other parts of the body.

In one embodiment, a pair of display mounts 23 and 24 can be provided along the middle section 21c of the head engagement device 20. In the preferred embodiment, each of the mounts will include an elongated top surface 23a and 24a, having any number of clamps or other such connectors 23b and 24b, respectively, for receiving and engaging the below described display assemblies.

In one embodiment, each of the mounts 23 and 24 can be fixedly secured onto the main body so as to be immobile in nature. In another embodiment, each of the mounts can be removably and/or slidingly connected onto the main body via additional clamps or other such connectors for allowing a user to adjust the position of the clamps (and the below described displays) as shown at arrow a.

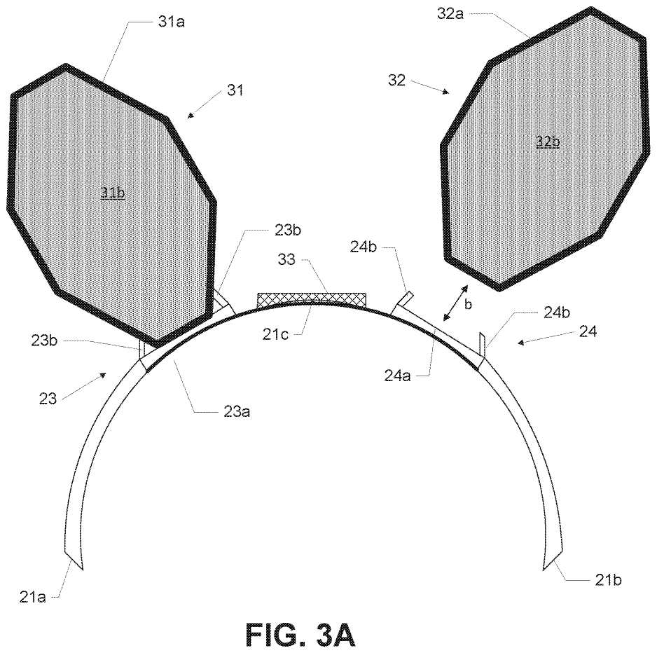

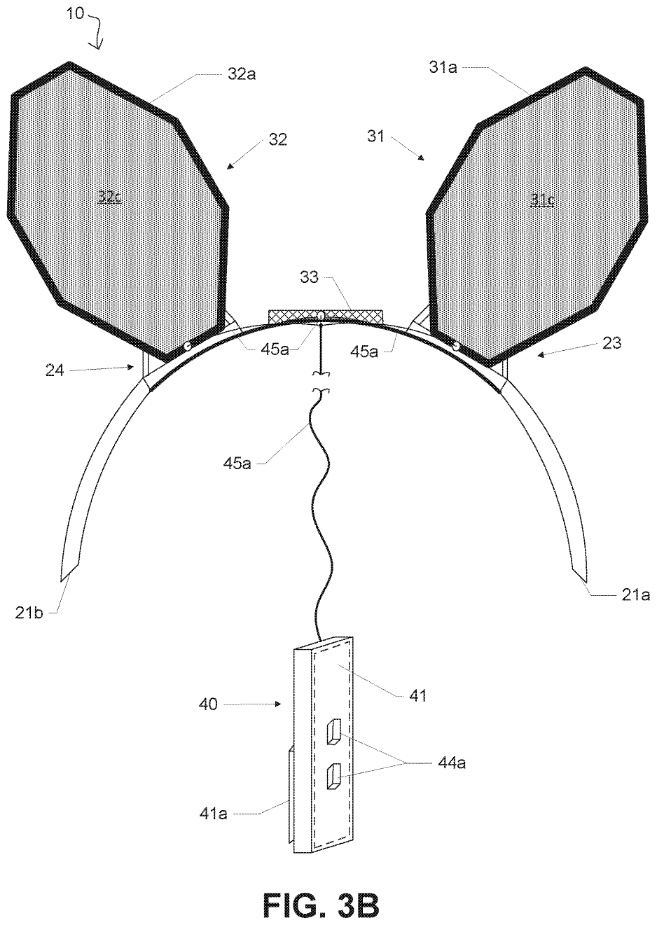

As shown best at FIG. 3A, one embodiment of the system 10 can include a pair of display assemblies 31 and 32 each having a housing 31a and 32a, and at least one forward facing display screen 31b and 32b, respectively.

The housings 31a and 32a provide structural support for the display screens and can be removably connected onto the head engagement device 20 via the mounts 23 and 24 and connectors 23b and 24b, respectively as shown by arrow b. As described herein, the screen housings can be constructed from any number of durable, water resistant and lightweight materials such as plastic, and can include any number of different fanciful shapes with any number of decorative elements. For example, in one nonlimiting embodiment, the display housings can include the illustrated fanciful rabbit-ear shapes, so that a user wearing the system would appear to have rabbit ears. Of course, any number of other shapes and sizes are also contemplated.

The ability of the system to receive and engage any number of different display assemblies is an important feature, as this allows a user to completely customize both the look of the system and the content the system plays by utilizing any number of different display assemblies. For example, a user may wish to utilize the illustrated ear-shaped display assemblies when attending a theme park and may wish to utilize different fanciful shaped assemblies (such as horn shaped assemblies, for example) when attending a concert.

Each of the display screens 31b and 32b can be connected to the system controller 40 and can include any type of device capable of displaying information in an analog or digital format to a viewer. Several nonlimiting examples include LCD display screens, LED display screens, OLED display screens, and electro-luminescent display screens, for example. In various embodiments, the display screens can also include or comprise a Graphic User Interface (GUI) capable of performing two-way communication with a device user.

In either instance, each of the screens can include any number of different shapes, which may be the same shape as the respective screen housing or different therefrom. Additionally, the system can include one or more speakers 33 which can also be connected to the system controller and can function to selectively play any type of music or other such sounds.

As shown best at FIG. 3B, the pair of display assemblies 31 and 32 can also include a pair of rear facing display screens 31c and 32c, respectively. As shown, each of the displays 31c/32c can be positioned within the housings 31a/32a and can be oriented directly opposite to the orientation of the displays 31b/32b, respectively. When so provided, individuals standing in front of a user wearing the system 10 are able to view contents of screens 31b and 32b and individuals standing behind the user are able to view contents of screens 31c and 32c.

Although described and illustrated with regard to two mounts and two display assemblies, this is for illustrative purposes only, as the inventive system can include any number of different mounts and displays for engagement by the head attachment device.

The system controller 40 can include a protective housing 41 that defines an interior space into which the electronic control components can be located. In one embodiment, a belt clip 41a or other such connector can be provided along the housing for allowing the controller to be secured the belt or other article of clothing that is worn by a user.

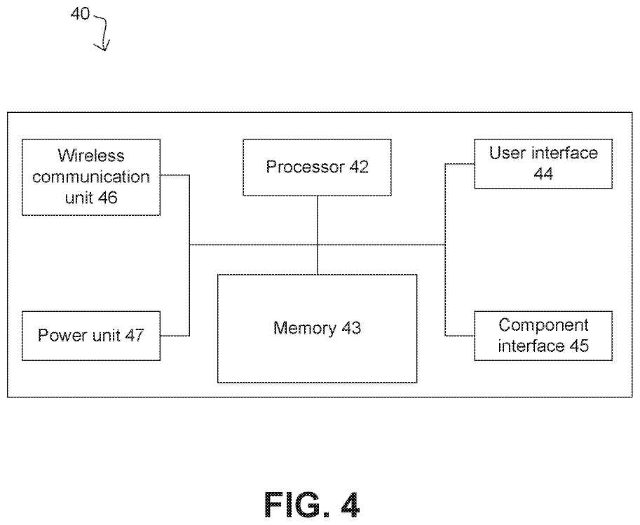

FIG. 4 is a simplistic block diagram illustrating one embodiment of the controller 40 that includes a processor 42 that is conventionally connected to an internal memory 43, a user interface device 44, component interface unit 45, a wireless communication unit 46, and/or a power unit 47.

Although illustrated as separate elements, those of skill in the art will recognize that one or more system components may comprise or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processing unit 42 can include one or more central processing units (CPU) or any other type of device, or multiple devices, capable of manipulating or processing information such as program code stored in the memory 43 in order to allow the system to perform the functionality described herein.

Memory 43 can act to store operating instructions in the form of program code for the processing unit 42 to execute. Although illustrated in FIG. 4 as a single component, memory 43 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example. The bulk storage device can contain any number of different programs that permit the processor to perform the functionality described herein and can also receive and store the exercise information for each user. Additionally, the bulk storage unit can store any type of content such as videos and animations for playback on the display screens and speaker during operation of the system.

The user interface device 44 can ideally be located along the main body 41 of the controller and can include any number of different buttons 44a, switches and/or touchscreen displays capable of sending and/or receiving operating instructions with a device user. For example, the interface device can act to initiate programming for instructing the processor 42 to play stored content on the display assemblies, to switch the system between an ON and OFF state, and/or to pair the communication unit with an external device, and so on.

The component interface unit 45 can function to provide a communicative link between the processing unit 42, the user interface device 44, the display assemblies 31 and 32 and the speaker 33. In this regard, the component interface unit can include any number of power and communication cables 45a along with any number of PIC microcontrollers, standard bus, internal bus, connection cables, wireless receiver and/or associated hardware such as USB cables and connectors, and other such hardware capable of linking the various components. Of course, any other means for providing two-way communication between the system components can also be utilized herein.

The communication unit 46 can include any number of components capable of sending and/or receiving electronic signals with another device, either directly or over a network. In the preferred embodiment, the communication unit 46 can include a Wi-Fi or Bluetooth transceiver for communicating directly with a user smartphone 1 for example, that is running a mobile application 15 that can be downloaded onto the user device and installed as an application.

Of course, any number of other transmission and reception mechanisms and protocols can also be utilized herein, several nonlimiting examples include cellular transceivers, radio transmitters and/or network adapter(s) functioning to communicate over a WAN, LAN, or the internet via an internet service provider, among others, for example.

The power unit 47 can include any number of different components capable of providing the necessary power requirements to each element of the system. In the preferred embodiment, the power unit can include one or more batteries that can be positioned within the controller housing 41. The batteries can be removable via a housing opening or can be rechargeable in nature via an integrated charging port or via inductive charging, for example.

Although described above with regard to the controller 40 being located within a discrete housing that is worn by a user, this is for illustrative purposes only. To this end, other embodiments are contemplated wherein the controller housing is coupled directly onto the head engagement device 20.

In operation, a smartphone 1 or other such device running an application 15 (See FIG. 1) can communicate directly with the system controller. The app can allow a user to control the operation of the head mounted system and can provide any type of content such as various text, audio, images, video, and/or interactive elements for dissemination via the display assemblies and speaker. The content can be uploaded and stored within the onboard memory of the system controller or can be live streamed to the controller for immediate or delayed playback. The content can be customized by the user and played at any desirable time.

Accordingly, the above noted system can allow a user to upload and display any type of content when attending events such as concerts, sporting contests, theme parks, and other such activities, so as to improve their experience and better feel like part of the festivities in a way not previously possible.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings, and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A customizable display system, comprising:
a head engagement device that is configured to engage a human head;
at least one display screen that is connected to the head engagement device; and
a controller that is configured to provide content for playback on the at least one display screen.

2. The system of claim 1, wherein the head engagement device includes an elongated semicircular-shaped body having a first end, a second end and a middle section.

3. The system of claim 2, further comprising:
padding that is positioned along an inside facing surface of the middle section of the head engagement device.

4. The system of claim 1, further comprising:
a speaker that is connected to the controller, said speaker being configured to play the content provided by the controller.

5. The system of claim 1, wherein the controller includes a main body for housing a processor, a memory, and a power unit.

6. The system of claim 5, wherein the memory is configured to receive and store the content for playback on the at least one display screen.

7. The system of claim 1, wherein the controller includes a wireless communication unit that is configured to receive operating instructions from an external device.

8. The system of claim 1, wherein the controller includes a wireless communication unit that is configured to receive content from an external device.

9. The system of claim 1, further comprising:
an application for execution on a processor enabled device, said application including functionality for communicating with the controller.

10. The system of claim 9, wherein said communicating includes sending the content to the controller, and providing operating instructions to the controller.
